(19) United States
(12) Patent Application Publication
(10) Pub. No.: US 2022/0097170 A1
(43) Pub. Date: Mar. 31, 2022

(54) CURRENT AUXILLARY FRICTION ADDITIVE MANUFACTURING DEVICE AND METHOD

(71) Applicants: NO. 59 INSTITUTE OF CHINA ORDNANCE INDUSTRY, Chongqing (CN); Harbin Institute of Technology at Weihai, Weihai City (CN)

(72) Inventors: Qiang CHEN, Chongqing (CN); Li ZHOU, Weihai (CN); Mingrun YU, Weihai (CN); Zili ZHANG, Weihai (CN); Fei XU, Weihai (CN); Jicai FENG, Weihai (CN); Shuhai HUANG, Chongqing (CN); Han XIAO, Chongqing (CN); Dayu SHU, Chongqing (CN); Yang WU, Chongqing (CN)

(21) Appl. No.: 17/137,297

(22) Filed: Dec. 29, 2020

Related U.S. Application Data
(63) Continuation of application No. PCT/CN2020/140210, filed on Dec. 28, 2020.

(30) Foreign Application Priority Data
Sep. 30, 2020 (CN) 202011070005.3

(51) Int. Cl. B23K 20/12; B33Y 30/00; B33Y 10/00; B23K 37/04

(52) U.S. Cl. CPC B23K 20/1215; B33Y 30/00; B23K 2103/16; B23K 37/0461; B33Y 10/00

(57) ABSTRACT

The present invention provides a current auxiliary friction additive manufacturing device, which includes a friction coating device, a movable worktable and a current generation device. The device is specially used for current auxiliary friction additive manufacturing. The present invention further provides a current auxiliary friction additive manufacturing method. The present invention promotes interface reaction and interface bonding between a coating and a substrate or between the coatings in the traditional friction additive manufacturing process, and improves the bonding strength and service performance of the coating. The method is suitable for manufacturing various thermoplastic conductive consumables such as friction additives of aluminum alloy.

### CROSS-REFERENCE TO RELATED APPLICATIONS

This application is a continuation of International Patent Application No. PCT/CN2020/140210, filed on Dec. 28, 2020, which claims the benefit of priority from Chinese Patent Application No. 202011070005.3, filed on Sep. 30, 2020. The content of the aforementioned applications, including any intervening amendments thereto, is incorporated herein by reference in its entirety.

### TECHNICAL FIELD

The present invention relates to the field of additive manufacturing and current auxiliary processing, and particularly relates to a current auxiliary friction additive manufacturing device and method.

### BACKGROUND OF THE PRESENT INVENTION

With increasing awareness of environmental protection, people attach great importance to reducing resource consumption and environmental pollution. Friction additive is used as an advanced additive manufacturing technology, and its principle is to use a successive accumulation method of a metal material to manufacture a physical part, which has the characteristics of high efficiency, high quality, low energy consumption, low pollution, etc. This technology utilizes a friction coating technology for layer-by-layer preparation and accumulation to obtain the physical part. The friction coating technology is widely used in aircraft material joint, petrochemical and additive manufacturing, and maintenance and re-manufacturing of equipment parts such as agricultural machinery because it can obtain a welding coating with good bonding integrity on the surface of a substrate material. The principle of a rotating consumable friction additive technology is to take friction heat between a consumable and the substrate material as power to deposit the consumable on the surface of the substrate material, thereby realizing the friction additive.

The high-speed rotating consumable friction additive is specifically to first make the consumable that rotates at high speed contact the substrate material to generate a viscoplastic boundary layer under the action of axial pressure. Then, under the action of the friction heat and pressure, atomic diffusion occurs between the plastically-deformed consumable and substrate material, thereby realizing metallurgic bonding. However, when the friction additive is manufactured on the surface of the substrate with a large thickness, the friction heat is insufficient to maintain the temperature between a coating and the substrate because the substrate has good heat emission condition. At a low temperature, the diffusion speed of metal atoms is low, and effective metallurgic connection cannot be formed on the interface. During cooling, interface fracture is prone to form at the end of the coating due to the internal stress.

The induction heating effect is used in the prior art to heat the consumable, which still has problems as follows: (1) by using the induction heating way, the volume of a mechanical structure in a surfacing position is increased, thereby increasing the processing difficulty, and more particularly increasing the processing difficulty of the additive in some special circumstances such as on the bottom of a concave deep groove; and (2) an interface between the consumable and the substrate is difficult to be subjected to the induction heating directly; the induction heating directly acts on an area nearby the interface; and the interface is heated through heat transfer, so that the energy utilization rate is low.

### SUMMARY OF THE PRESENT INVENTION

According to the above background, a purpose of the present invention is to solve the problems that a conventional friction additive manufacturing technology is weak in interface bonding performance.

The purpose of the present invention is realized through the following measures:

A current auxiliary friction additive manufacturing device includes:

a friction coating device 1 with a feeding tool head 2 used to feed consumables;

a movable worktable with a substrate 3 fixedly arranged thereon;

a current generation device 4 with electrodes connected respectively with the tool head 2 and the substrate 3, used to supply current to an additive manufacturing process.

The above device is specially used for the current auxiliary friction additive manufacturing and mainly includes a friction additive device, a current application device and the movable worktable. The consumables are fixed on the friction additive device. The substrate is fixed on the movable worktable. The current application device acts on a bonding position between a substrate surface and the consumable. The friction additive manufacturing is carried out when the current auxiliary consumables rotate at high speed.

According to a current auxiliary friction additive manufacturing method using the above device, thermoplastic conductive materials are subjected to continuous solid precipitation under the action of current and stacked layer by layer to achieve additive.

The method using the above device to manufacture current auxiliary rotating consumable friction additive includes the following steps:

(1) a preparation phase: firstly installing consumables on a friction additive device, installing a substrate on a movable worktable, and then presetting various technological parameters of an additive preparation process;

(2) an additive phase: starting the friction additive device and a current device, enabling the consumables and the current to jointly act on the substrate surface and to move relative to the substrate, smearing a first layer on the substrate surface, continuously or intermittently repeating the coating phase, and performing layer-by-layer friction coating and stacking to an n<th> layer, thereby implementing the additive manufacturing;

(3) an end phase: raising the consumables, powering off the current application device, and ending the friction additive.

In the step (2), the consumables rotate continuously in the coating process; and the current acts on a contact position between the consumables and the substrate material.

The above applied current is alternating current or direct current. The type and polarity of the current are related to the type of the consumables and a surfacing technology.

In the above step (2), after the current generation device is started, a positive electrode of the current generation device inputs the alternating current to a consumable stick, and the current finally enters a negative electrode of the current generation device through the substrate surface. The current frequency is 20 kHz-50 kHz, and the current density is 2 A/mm²-50 A/mm².

Further, the negative electrode of the current generation device acts on positions of the material surface such as an upper surface, a lower surface and a side surface of the substrate. The action position of the negative electrode of the current generation device on the surface of the substrate has a maximal distance of 50 mm to the edge of the consumable.

Further, preparation parameters of a single layer are as follows: an angle between the consumable and a perpendicular line of the substrate surface is 0°-5°; a rotation speed of the consumable is 900 rpm-8000 rpm; if initial pressing is necessary at a coating phase, an initial pressing depth is 0-5 mm, and an initial pressing speed is 3 mm/min-12 mm/min; an advancing speed at a single-layer phase is 100 mm/min-800 mm/min; and the pressing speed of the consumable in the advancing process is 0.4 mm/s-0.6 mm/s.

In the step (1), preset parameters at the preparation phase include but are not limited to a feed rate, a rotation speed, pressure or pressing speed.

The above consumables are thermoplastic materials with conductivity. The materials include but are not limited to metals, metal-based composite materials, thermoplastic organic materials and other materials with conductivity.

The present invention has the beneficial effects:

1. The present invention discloses a current auxiliary friction additive preparation method and a friction additive process and device used therein. The rotating consumables directly contact the surface of the substrate material under the action of pressure, and current is applied to a contact position between the surface of the substrate material and the consumable at the same time; and meanwhile, the rotating consumables rotate in a direction perpendicular to a rotating axis to form a coating. The coating forming method is repeated for layer-by-layer stacking to realize the additive manufacturing. The method promotes interface reaction and interface bonding between the coating and the substrate or between the coatings in the traditional friction additive manufacturing process, and improves the bonding strength and service performance of the coating. A shear specimen of 10 mm*10 mm is prepared on the coating to test shear strength of the coating. The shear strength of the coating after using the current assistance is improved. The method is suitable for manufacturing various thermoplastic conductive consumables such as friction additives of aluminum alloy.

2. According to the present invention, through a resistance thermal effect between the end of the consumable and the interface of the substrate in current, the interface temperature between the coating material and the substrate is promoted, so that the interface reaction speed is further increased, and the interface bonding strength is enhanced. Through the resistance thermal effect between the end of the consumable and the interface of the coating in the current, the interface temperature between the coating material and the coating is increased, so that the interface reaction speed is promoted, and the interface bonding strength between the coatings is enhanced.

Compared with other thermal effects such as laser, electron beams, etc., through the resistance thermal effect between the end of the consumable and the interface of the substrate in the current, the solution has the advantages that the device structure is simple, and the production cost is low. A laser electron beam device is complex in structure and high in cost. Meanwhile, the electron beam heating is prone to generating radiation, so that further protection is needed. In addition, since the interface between the consumable and the substrate cannot be directly heated by the laser and electron beams, the heat acting efficiency is relatively low.

3. The application of the current in the conductive consumable can cause the thermal effect. Compared with other processing technologies, the heat generated by the current in the current processing technology based on this effect is mainly focused on an interface bonding position between the consumable and the substrate, so that the current energy can effectively act on the interface, the energy utilization efficiency can be increased, the interface temperature and the interface reaction speed can be increased, and the interface metallurgic bonding performance can be improved.

4. Compared with other additive manufacturing methods such as an electric arc additive manufacturing method, the friction additive belongs to the solid-phase additive manufacturing method. In the additive process, the heat input is small, and severe plastic deformation is introduced, so that a re-crystallized structure with fine grains is obtained. By means of a current auxiliary way, the additive interface temperature is increased, so that the problems that the heat produced by the friction is insufficient and the interface bonding strength is weak can be solved. The added current auxiliary device does not affect the additive manufacturing process and does not limit a practical application range.

### BRIEF DESCRIPTION OF THE DRAWINGS

FIG. 1 is a diagram of a device used in a current auxiliary rotating consumable friction additive manufacturing method;

FIG. 2 shows additive manufacturing on a bottom of a concave deep groove in the present invention;

FIG. 3 is a schematic diagram of a test device for bonding performance of an additive coating; and

FIG. 4 shows a test result of anti-shear capacity of a coating specimen.

### DETAILED DESCRIPTION OF THE PRESENT INVENTION

The present invention is further described below in combination with the accompanying drawings. The embodiments are preferred embodiments of the present invention, but the embodiments of the present invention are not limited by the present embodiment, and any other changes, modifications, substitutions, combinations and simplification made according to the spirit and principle of the present invention should be equivalent replacement modes, and shall be included in the protection scope of the present invention.

### EMBODIMENT 1

As shown in FIG. 1, an aluminum alloy consumable stick 2 is fixed on a friction coating device 1. A positive electrode of a current generation device is connected to the aluminum alloy consumable stick. A negative electrode of the current device is connected to a substrate material which is a steel plate 3.

During preparation of a single layer, the friction coating device is first started, and then the current generation device 4 (power supply) is started to generate current. Specifically referring to FIG. 1, the aluminum consumable stick for friction coating is first installed on the friction coating device; then the steel plate is fixed as the substrate material; next a coating material comes into contact with the surface of the steel plate during continuous rotation, and the current generation device (power supply) is powered on at the same time; and a current field is synchronously applied. An angle between the aluminum consumable stick and a perpendicular line of a steel plate surface is 0°-3°; a rotating speed of the aluminum consumable stick is 1400 rpm-1800 rpm; the aluminum consumable stick is initially pressed for 2 mm-4 mm, and a pressing speed is 4 mm/min; an advancing speed of the aluminum consumable stick is 75 mm/min-120 mm/min; and in the advancing process, current frequency is 20 kHz-50 kHz, and current density is 2 A/mm²-50 A/mm².

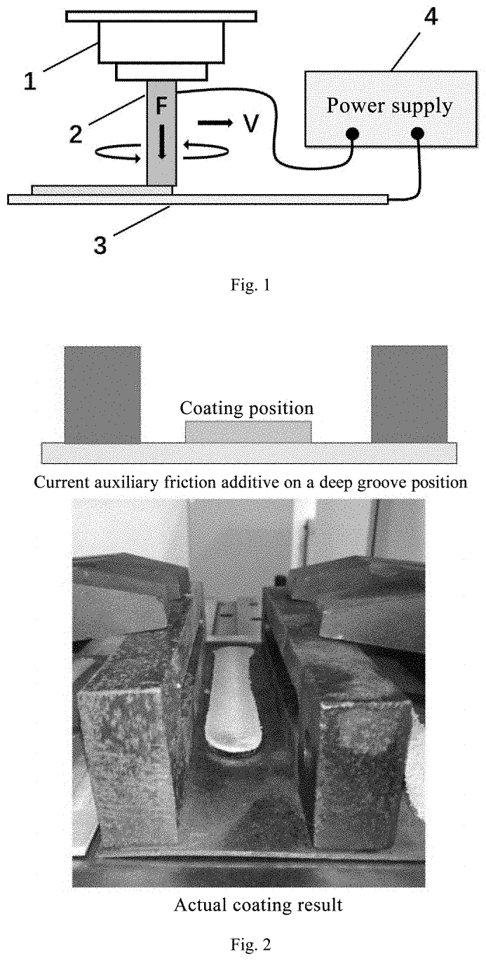

A schematic diagram of a coating preparation position and an actual coating result are shown in FIG. 2. A prepared coating is located on the bottom of a groove defined by clamps. The friction additive of aluminum alloy is performed on a material on the bottom of the groove defined by the clamps on both sides through the current auxiliary friction additive method.

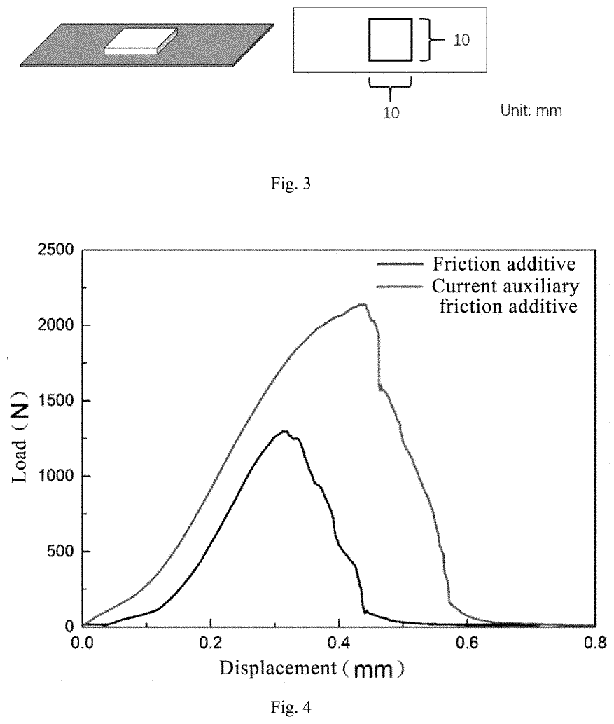

A test method for bonding performance of the additive coating includes: a shear specimen of 10 mm*10 mm is prepared on a coating through milling, as shown in FIG. 3.

The anti-shear capacity of the coating specimen is tested by a 30 KN universal testing machine. A test result of the bonding performance of the additive coating is shown in FIG. 4.

The anti-shear strength of a conventional friction additive coating is 1298N, and the anti-shear strength of the current auxiliary friction additive coating is 2134N. Compared with the conventional coating, the coating obtained by the current auxiliary way has higher anti-shear strength.

1. A current auxiliary friction additive manufacturing device, comprising:
a friction coating device 1 with a feeding tool head 2 used to feed consumables; a movable worktable with a substrate 3 fixedly arranged thereon; a current generation device 4 with electrodes connected respectively with the tool head 2 and the substrate 3, used to supply current to an additive manufacturing process.

2. A current auxiliary friction additive manufacturing method using the device of claim 1, comprising conducting continuous solid precipitation on thermoplastic conductive materials under the action of current, and stacking the materials layer by layer to achieve additive.

3. The current auxiliary friction additive manufacturing method according to claim 2, wherein the consumables rotate continuously in a coating process; and the current acts on a contact position between the consumables and a substrate material.

4. The current auxiliary friction additive manufacturing method according to claim 2, wherein in (2) coating phase, the current frequency is 20 kHz-50 kHz, and the current density is 2 A/mm²-50 A/mm².

5. The current auxiliary friction additive manufacturing method according to of claim 2, wherein the action position of a negative electrode of a current generation device on the surface of a substrate has a maximal distance of 50 mm to the edge of the consumable.

6. The current auxiliary friction additive manufacturing method according to claim 2, comprising the following steps:
(1) a preparation phase: firstly installing consumables on a friction additive device, installing a substrate on a movable worktable, and then presetting various technological parameters of an additive preparation process;
(2) an additive phase: starting the friction additive device and a current device, enabling the consumables and the current to jointly act on the substrate surface and to move relative to the substrate, smearing a first layer on the substrate surface, continuously or intermittently repeating the coating phase, and performing layer-by-layer friction coating and stacking to an n<th> layer, thereby implementing the additive manufacturing;
(3) an end phase: raising the consumables, powering off the current application device, and ending the friction additive.

7. The current auxiliary friction additive manufacturing method according to claim 2, wherein during preparation of a single layer, an angle between the consumable and a perpendicular line of the substrate surface is 0°-5°; a rotation speed of the consumable is 900 rpm-8000 rpm; if initial pressing is necessary at the coating phase, an initial pressing depth is 0-5 mm, and an initial pressing speed is 3 mm/min-12 mm/min; an advancing speed at a single-layer phase is 100 mm/min-800 mm/min; and the pressing speed of the consumable in the advancing process is 0.4 mm/s-0.6 mm/s.

8. The current auxiliary friction additive manufacturing method according to claim 2, wherein the materials comprise but are not limited to metals, metal-based composite materials or thermoplastic organic materials.
